(19) United States
(12) Patent Application Publication
(10) Pub. No.: US 2008/0216799 A1
(43) Pub. Date: Sep. 11, 2008

(54) Method for Operating a Fuel Pump

(75) Inventor: Arno Wunderlich, Sindelfingen (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/041,830

(22) Filed: Mar. 4, 2008

(30) Foreign Application Priority Data
Mar. 9, 2007 (DE) 10 2007 011 456.9

(51) Int. Cl. F02M 37/08

(52) U.S. Cl. 123/497

(57) ABSTRACT

In a method for operating a fuel pump of a motor vehicle, the fuel pump is driven by an electric motor in such a way that the fuel pump is driven by an energized electric motor in a defined rotational direction in order to feed fuel in the direction of an internal combustion engine. Accordingly, if it is detected that the fuel pump is blocked, the rotational direction of the fuel pump is changed at least once for a specific time period.

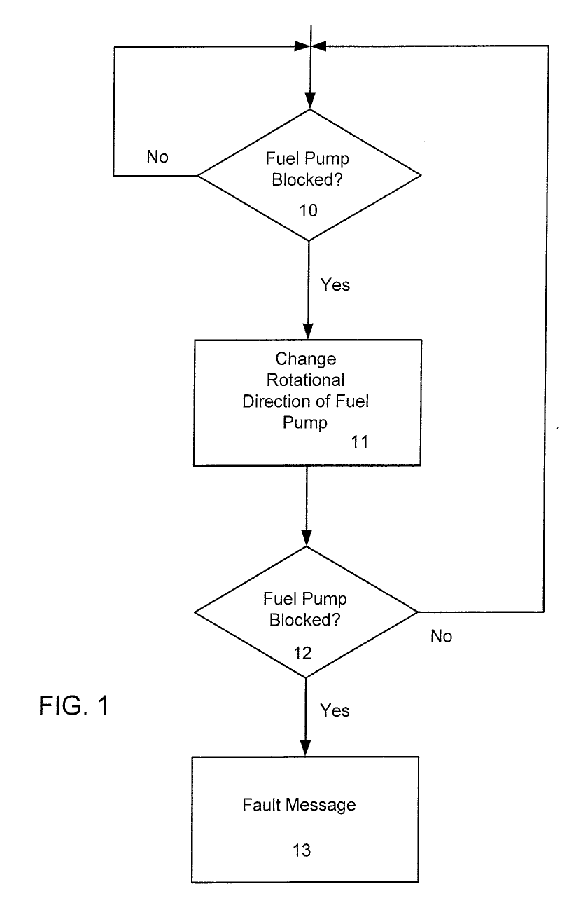

### CROSS-REFERENCE TO RELATED APPLICATION

This application claims the priority, under 35 U.S.C. §119, of German application DE 10 2007 011 456.9, filed Mar. 9, 2007; the prior application is herewith incorporated by reference in its entirety.

### BACKGROUND OF THE INVENTION

### FIELD OF THE INVENTION

The invention relates to a method for operating a fuel pump.

A fuel pump of a motor vehicle which serves to feed fuel in the direction of an internal combustion engine of the motor vehicle has an electric motor in order to drive the fuel pump. A fuel pump is driven here by the electric motor in such a way that the energized electric motor drives the fuel pump in a defined rotational direction in order to feed fuel in the direction of the internal combustion engine.

Impurities in the fuel which is to be fed in the direction of the internal combustion engine by the fuel pump can lead to blockage of the fuel pump, in which case fuel is no longer fed in the direction of the internal combustion engine and as a result the motor vehicle becomes immobile. Hitherto it has not been possible to eliminate such a blockage in a fuel pump so that a blocked fuel pump had to be replaced at the workshop. This is complicated and expensive.

### BRIEF SUMMARY OF THE INVENTION

It is accordingly an object of the invention to provide a method for operating a fuel pump that overcomes the above-mentioned disadvantages of the prior art methods of this general type.

With the foregoing and other objects in view there is provided, in accordance with the invention, a method of operating a fuel pump of a motor vehicle. The method includes the steps of: driving the fuel pump with an electric motor such that the fuel pump is driven by an energized electric motor in a defined rotational direction for feeding fuel in a direction of an internal combustion engine; and changing a rotational direction of the fuel pump at least once for a specific time period if it is detected that the fuel pump is blocked.

According to the invention, if it is detected that the fuel pump is blocked, the rotational direction of the fuel pump is changed at least once for a specific time period.

The method according to the invention for operating a fuel pump makes it possible for the first time to eliminate the blockage of a fuel pump. If, accordingly, a blocked fuel pump is present, the rotational direction of the fuel pump is changed at least once for a specific time period, as a result of which the blockage of the fuel pump can be eliminated in the vast majority of cases. The fuel pump has to be replaced at the workshop only if the method according to the invention does not permit the blockage of a fuel pump to be eliminated. This permits cost saving.

If it is detected that the fuel pump is blocked, the rotational direction of the fuel pump is immediately changed repeatedly in succession for a specific time period in order to eliminate the blockage of the fuel pump by shaking it free.

In accordance with an added mode of the invention, there is the step of changing the rotational direction of the fuel pump repeatedly in succession for a further specific time period to eliminate a blockage of the fuel pump by shaking the blockage free if it is detected that the fuel pump is blocked.

In accordance with another mode of the invention, there are the steps of providing a DC electric motor as the electric motor for driving the fuel pump; and concluding that the fuel pump is blocked in such a way that despite the energized electric motor no build up of pressure takes place in a fuel system.

In accordance with an additional mode of the invention, there is the step of changing the rotational direction of the fuel pump using a relay to interact with the DC electric motor.

In accordance with a further mode of the invention, there is the step of changing the rotational direction of the fuel pump by changing an energization of an H bridge into which the DC electric motor is connected.

In accordance with another added mode of the invention, there are the steps of providing an EC electric motor as the electric motor for driving the fuel pump; and concluding that the fuel pump is blocked in such a way that despite the energized electric motor no build up of pressure takes place in a fuel system.

In accordance with another additional mode of the invention, there are the steps of providing an EC electric motor as the electric motor for driving the fuel pump; and detecting a blocked fuel pump with an aid of a position sensor integrated into the EC electric motor.

In accordance with a further added mode of the invention, there are the steps of providing an EC electric motor as the electric motor for driving the fuel pump; and detecting a blocked fuel pump with an aid of an induction measurement at non-energized coils of the EC electric motor.

In accordance with a concomitant mode of the invention, there is the step of changing the rotational direction of the fuel pump by use of a control unit of the EC electric motor.

Other features which are considered as characteristic for the invention are set forth in the appended claims.

Although the invention is illustrated and described herein as embodied in a method for operating a fuel pump, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION THE DRAWING

The single FIGURE of the drawing is a signal flowchart showing a method for operating a fuel pump according to the invention.

### DETAILED DESCRIPTION OF THE INVENTION

The present invention relates to a method for operating a fuel pump of a motor vehicle. Such a fuel pump is driven by an electric motor, specifically in such a way that when the electric motor is energized, the fuel pump is driven in a defined rotational direction in order to feed fuel in the direction of an internal combustion engine.

Owing to impurities in the fuel, the fuel pump may become blocked. Therefore, during operation of the fuel pump, continuous checking is carried out to determine whether the fuel pump is blocked as shown in block 10 of the signal flowchart in the FIGURE. If it is detected in this context that the fuel pump is not blocked, the system branches back to block 10 in the sense of a loop. If, in contrast, it is detected that the fuel pump is blocked, the system branches to block 11.

In order to eliminate such a blockage of the fuel pump, according to block 11 it is proposed according to the invention that if it is detected that the fuel pump is blocked, the rotational direction of the fuel pump is changed at least once for a specific time period. If it is detected that the fuel pump is blocked, the rotational direction of the fuel pump is preferably changed repeatedly in succession for a specific time period in order in this way to eliminate the blockage of the fuel pump by shaking it free. According to block 12, it is then checked whether the measure according to block 11 was able to eliminate the blockage.

If it is detected in block 12 that the blockage has been eliminated, the system branches back to block 10 and the fuel pump can then be operated again in the defined rotational direction in order to feed fuel to the internal combustion engine. If, in contrast, it is detected in block 12 that the blockage is not eliminated, the system branches to block 13. In block 13, a message is then generated to the effect that the fuel pump has to be replaced.

According to a first alternative of the invention according to which the fuel pump is driven by a DC electric motor, it is concluded in blocks 10 and 12 that the fuel pump is blocked in such a way that despite an energized electric motor no build up of pressure takes place in the fuel system. For this purpose, a measured value of a pressure sensor which is integrated into the fuel system is evaluated. If the pressure sensor does not detect any build up of pressure in the fuel system despite an energized DC electric motor, it is concluded that a fuel pump is blocked.

In order to eliminate the blockage of a fuel pump which is driven by a DC electric motor, in block 11 the rotational direction of the fuel pump is changed either by use of a relay which interacts with the DC electric motor or by changing the energization of an H bridge into which the DC electric motor is connected. By repeatedly switching the relay in succession or by repeatedly changing the energization of the H bridge in succession, the rotational direction of the fuel pump can be changed repeatedly in succession.

According to a second alternative of the present invention, the fuel pump is driven by an EC electric motor. Then, if the fuel pump is driven by an EC electric motor, it is possible to conclude, in a way corresponding to the DC electric motor in blocks 10 and 12, that a fuel pump is blocked in such a way that despite an energized EC electric motor no build up of pressure takes place in the fuel system.

If a position sensor, for example a Hall sensor, is integrated into the EC electric motor which serves to drive the fuel pump, it is also thus possible to conclude in blocks 10 and 12 that there is a blocked fuel pump by evaluating the measurement signal of the position sensor.

Alternatively it is also possible that if the fuel pump is driven by an EC electric motor, induction measurement is carried out in blocks 10 and 12 at respectively non-energized coils of the EC electric motor in order to conclude that there is a blocked fuel pump. If, in fact, the rotor of the EC electric motor does not rotate, the latter does not in fact induce any voltage in the non-energized coils of the EC electric motor. As a result, it is then also possible to conclude that there is a blocked fuel pump.

If it is concluded that a fuel pump which is driven by an EC electric motor is blocked, the change in the rotational direction of the fuel pump is carried out in block 11 by a control unit of the EC electric motor.

Accordingly, it lies within the sense of the present invention that if blockage of a fuel pump is detected, the rotational direction of the fuel pump is changed at least once, preferably repeatedly in succession, for a specific time period in order to eliminate the blockage of the fuel pump.

In particular, in order to eliminate a blockage of the fuel pump the rotational direction of the fuel pump is changed five to ten times in succession, as a result of which a blockage can be eliminated in the vast majority of cases. The fuel pump has to be replaced at the workshop only if this measure does not lead to elimination of the blockage of a fuel pump.

The method according to the invention can be used in fuel pumps for diesel fuels, petrol fuels or any other fuels.

1. A method of operating a fuel pump of a motor vehicle, which comprises the steps of:
driving the fuel pump with an electric motor such that the fuel pump is driven by an energized electric motor in a defined rotational direction for feeding fuel in a direction of an internal combustion engine; and
changing a rotational direction of the fuel pump at least once for a specific time period if it is detected that the fuel pump is blocked.

2. The method according to claim 1, which further comprises changing the rotational direction of the fuel pump repeatedly in succession for a further specific time period to eliminate a blockage of the fuel pump by shaking the blockage free if it is detected that the fuel pump is blocked.

3. The method according to claim 1, which further comprises:
providing a DC electric motor as the electric motor for driving the fuel pump; and
concluding that the fuel pump is blocked in such a way that despite the energized electric motor no build up of pressure takes place in a fuel system.

4. The method according to claim 3, which further comprises changing the rotational direction of the fuel pump using a relay to interact with the DC electric motor.

5. The method according to claim 3, which further comprises changing the rotational direction of the fuel pump by changing an energization of an H bridge into which the DC electric motor is connected.

6. The method according to claim 1, which further comprises:
providing an EC electric motor as the electric motor for driving the fuel pump; and
concluding that the fuel pump is blocked in such a way that despite the energized electric motor no build up of pressure takes place in a fuel system.

7. The method according to claim 1, which further comprises:
providing an EC electric motor as the electric motor for driving the fuel pump; and
detecting a blocked fuel pump with an aid of a position sensor integrated into the EC electric motor.

8. The method according to claim 1, which further comprises:
providing an EC electric motor as the electric motor for driving the fuel pump; and
detecting a blocked fuel pump with an aid of an induction measurement at non-energized coils of the EC electric motor.

9. The method according to claim 6, which further comprises changing the rotational direction of the fuel pump by use of a control unit of the EC electric motor.
